(19) United States
(12) Patent Application Publication
(10) Pub. No.: US 2023/0395816 A1
(43) Pub. Date: Dec. 7, 2023

(54) TERNARY CATALYSTS FOR OXYGEN EVOLUTION REACTIONS

(71) Applicant: Advent Technologies Holdings, Inc., Boston, MA (US)

(72) Inventors: Ian Kendrick, Salem, MA (US); Sanjeev Mukerjee, Mansfield, MA (US)

(21) Appl. No.: 18/328,735

(22) Filed: Jun. 3, 2023

Related U.S. Application Data
(60) Provisional application No. 63/348,621, filed on Jun. 3, 2022.

(51) Int. Cl. H01M 4/90; C25B 9/23

(52) U.S. Cl. CPC H01M 4/9041; C25B 9/23; H01M 2004/027

(57) ABSTRACT

Aspects of the invention provide ternary catalysts for oxygen evolution reactions comprised of Ni, Fe, and a third metal X, where X comprises any of Co, Zn, Al, Mn, or Cr. Still other aspects of the invention provide such ternary catalysts, where the molar ratios in preparation of the catalysts of Ni, Fe and X are any of 8:1:1, 7:2:1, 7:1:2, 6:3:1, 6:2:2, or 6:1:3 where the first number refers to nickel; the second number, iron; and, the third number, the metal X. Further aspects of the invention provide such ternary catalysts prepared by reducing corresponding salts of each of the metals Ni, Fe and X in the presence of aniline to yield respective oxides, hydroxides, and/or oxyhydroxides of each of those metals and, then, alloying a mixture of same in argon to yield the catalyst.

### DESCRIPTION OF THE RELATED ART

This application claims the benefit of U.S. Patent Application Ser. No. 63/348,621, filed Jun. 3, 2022, titled TERNARY CATALYSTS FOR OXYGEN EVOLUTION REACTIONS, the teachings of which are incorporated herein by reference.

### STATEMENT REGARDING FEDERALLY SPONSORED RESEARCH OR DEVELOPMENT

This invention was made with government support under Grant DE-EE0008082, awarded by the Department of Energy. The government has certain rights in the invention.

The invention pertains to catalysts for use in oxygen evolution reactions. It has application, by way of non-limiting example, in anodes, membrane electrode assemblies and other apparatus for electrolysis.

Demand for hydrogen is expected to rapidly increase with the widespread adoption of hydrogen-air fuel cells in stationary and mobile applications. The inherent contradiction of this emerging paradigm is that while generating electricity with a fuel cell yields no greenhouse gases, an overwhelming percentage of hydrogen is produced using fossil fuels or their derivatives as feedstock. See, Lehner, F. and D. Hart, Chapter 1—The importance of water electrolysis for our future energy system, in Electrochemical Power Sources: Fundamentals, Systems, and Applications, T. Smolinka and J. Garche, Editors. 2022, Elsevier. p. 1-36. Hydrogen production via electrolysis is a process where a current is applied to an aqueous electrolyte solution and the water is split into its oxygen and hydrogen components. Electrolysis is a mature technology that has its origins in the late 1800s and used liquid alkaline electrolytes. The introduction of the proton-exchange membrane (PEM) Nafion in the 1960's allowed for membrane-based electrolyzers that were more compact, and scalable and the hydrogen evolved was easier to pressurize. The main drawback to PEM-based electrolyzers is that the cost of the noble-metal anodic oxygen evolution reaction (OER) and cathodic hydrogen evolution reaction (HER) catalysts are too high for the widespread adoption of this technology.

The relatively recent introduction of anion exchange membranes (AEM) allows for cheaper and more abundant metals to be used in electrochemical reactors that would otherwise corrode at higher pHs.

Of the non-noble metal OER catalysts, nickel is a common primary component, support medium, or both and has been widely used as the anode material in water electrolyzers. See, Pletcher, D. and F. C. Walsh, Industrial electrochemistry. 1990: Springer Science & Business Media; Goodenough, J., Electrodes of Conductive Metallic Oxides: Part BS Trasatti (Editor). Studies in Physical and Theoretical Chemistry, Vol. 11. Elsevier, Amsterdam, 1981, xvi+366 pp. $72.25, Dfl. 170.00. 1982, Elsevier; Gras, J. and P. Spiteri, Corrosion of stainless steels and nickel-based alloys for alkaline water electrolysis. International journal of hydrogen energy, 1993. 18(7): p. 561-566. The improvement of nickel OER catalysis in the presence of iron was first observed in 1987 by Corrigan when 0.01% by weight of iron was introduced via contamination. Corrigan went on to demonstrate that a nickel catalyst with 10-50% wt of iron can improve OER activity. See, Corrigan, D. A., The catalysis of the oxygen evolution reaction by iron impurities in thin film nickel oxide electrodes. Journal of The Electrochemical Society, 1987. 134(2): p. 377. Since then, hundreds of articles have been published regarding NiFeOₓ OER catalysts, although the role of the iron is still a subject of debate.

In 2015, Bates et al. published a manuscript describing how the incorporation of a third metal, in this case, cobalt, further improved the performance of Ni-based metal-metal oxide OER catalysts. See, Bates, M. K., et al., Charge-transfer effects in Ni—Fe and Ni—Fe—Co mixed-metal oxides for the alkaline oxygen evolution reaction. ACS Catalysis, 2016. 6(1): p. 155-161. They observed that while increased OER activity is observed in NiFe catalysts, Ni²⁺ is oxidized to its more conductive and catalytically active Ni³⁺ oxidation state a higher potential than when nickel is used alone. Conversely, when a NiCo catalyst is used, nickel oxidation occurs at a lower potential since the presence of cobalt negatively affects OER activity. Nevertheless, they reported that the incorporation of cobalt into a NiFe catalyst resulted in the oxidation of nickel at lower potentials and improved the overall OER activity when compared to NiFe, thus demonstrating the viability and utility of ternary catalysts in the context of OER.

An object of the invention is to provide improved catalysts and, more particularly, by way of non-limiting example, improved catalysts for use in oxygen evolution reactions.

A further related object of the invention is to provide improved anodes, membrane electrode assemblies and electrolyzer cells for hydrogen (and oxygen) production via electrolysis.

### SUMMARY OF THE INVENTION

The foregoing objects are among those achieved by the invention, aspects of which provide ternary catalysts comprised of Ni, Fe, and a third metal X, where X comprises any of Co, Zn, Al, Mn, or Cr. Related aspects of the invention provide such ternary catalysts, where X consists of any of the elements Co, Zn, Al, Mn, or Cr.

Still other aspects of the invention provide ternary catalysts comprised of Ni, Fe, and X, prepared in molar ratios of 8:1:1, 7:2:1, 7:1:2, 6:3:1, 6:2:2, or 6:1:3, where the first number of the ratio refers to nickel; the second number, iron; and, the third number, the metal X.

Yet still other aspects of the invention provide methods of preparing ternary catalysts, e.g., of the types described above.

According to one such aspect, such ternary catalysts are prepared by reducing corresponding salts of each of the metals Ni, Fe and X in the presence of aniline to yield respective oxides, hydroxides, and/or oxyhydroxides of each of those metals and, then, alloying a mixture of same in argon to yield the catalyst. Related aspects of the invention provide such methods in which the reduction in the presence of aniline is used to limit particle size of the oxides, hydroxides, and/or oxyhydroxides.

Still other aspects of the invention provide improved anodes comprising ternary catalysts of the types described above for promoting oxygen evolution reactions, e.g., in electrolyzer cells. Related aspects of the invention provide such anodes in which the ternary catalyst is free-standing. Further related aspects of the invention provide such anodes that lack a metallic support layer.

Other related aspects of the invention provide membrane electrode assemblies, e.g., for electrolysis, as well as to provide improved electrolyzer cells utilizing such membrane electrode assemblies, all of which employ catalysts and/or anodes as described above.

Further aspects of the invention are evident in the text that follows and in the drawings and claims filed herewith.

### BRIEF DESCRIPTION OF THE DRAWINGS

A more complete understanding of the invention may be attained by reference to the drawings, in which:

FIG. 1 depicts an ionomer membrane-based electrolyzer cell utilizing an anode employing a ternary catalyst according to the invention;

FIG. 2 depicts an X-ray diffraction pattern of a NiFeCo catalyst according to the invention with atomic ratios of 6:3:1 (Ni:Fe:Co);

FIG. 3 depicts a half-cell rotating disc electrode polarization curve of a NiFeCo catalyst according to the invention with atomic ratios of 6:3:1 (Ni:Fe:Co);

FIG. 4 depicts polarization curves of anion exchange membrane electrolyzer cells using OER catalysts prepared either by using a reducing agent dissolved/dispersed in a polar aprotic solvent (solid) or water (dashed);

FIG. 5 depicts polarization curves of anion exchange membrane electrolyzer cells with anodes using NiFeCo, NiFeMn, NiFeZn and NiFeAl catalysts according to the invention; and

FIG. 6 depicts a method of making a catalyst according to the invention.

### DESCRIPTION OF THE ILLUSTRATED EMBODIMENT

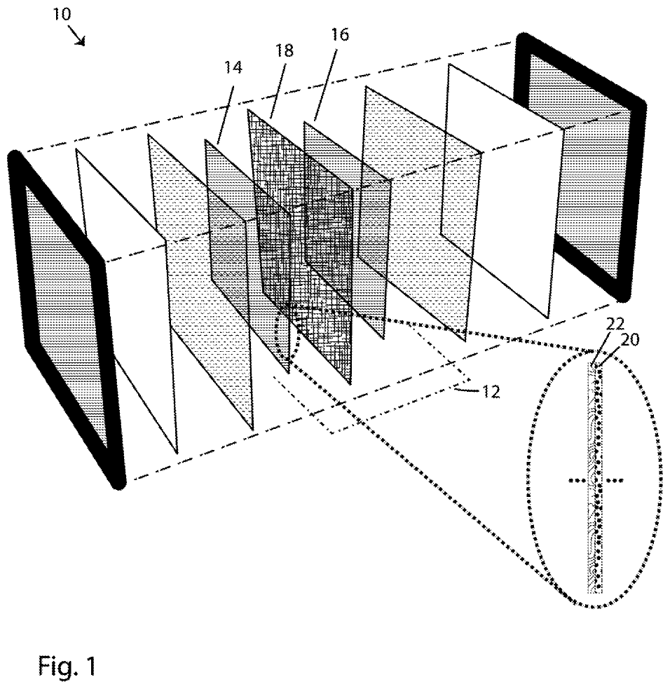

FIG. 1 depicts an ionomer membrane-based electrolyzer cell 10 of the type having an anode employing a ternary catalyst according to the invention. The cell includes membrane electrode assembly (MEA) 12 according to the invention, which includes gas diffusion electrodes, namely, anode 14, cathode 16 and ion-conductive membrane 18, all per convention in the art as adapted in accord with the teachings hereof. The cell 10 and MEA 12 may include other componentry, again, per convention in the art as adapted in accord with the teachings hereof. Thus, for example, the anode 14 can comprise, by way of non-limiting example, a catalyst layer 20 as described below and a support layer 22 of the type known in the art as adapted in accord with the teachings hereof. As indicated by ellipses in the drawing, the anode may include other layers of types known in the art as adapted in accord with the teachings hereof.

Catalyst layer 20 of the illustrated embodiment comprises a novel ternary catalyst for oxygen evolution reactions (OER) at the anode 14 comprised of Ni, Fe, and third metal, X. This catalyst is prepared by reduction of the corresponding salt of each metal in the presence of aniline to limit the particle size and to yield the oxide, hydroxide, or oxyhydroxide of each respective metal. A mixture of those oxides, hydroxides and/or oxyhydroxides is then alloyed in argon to yield the catalyst. In the illustrated embodiment, X consists of any of the elements Co, Zn, Al, Mn, or Cr. In other embodiments, X can be alloy that includes any of those elements.

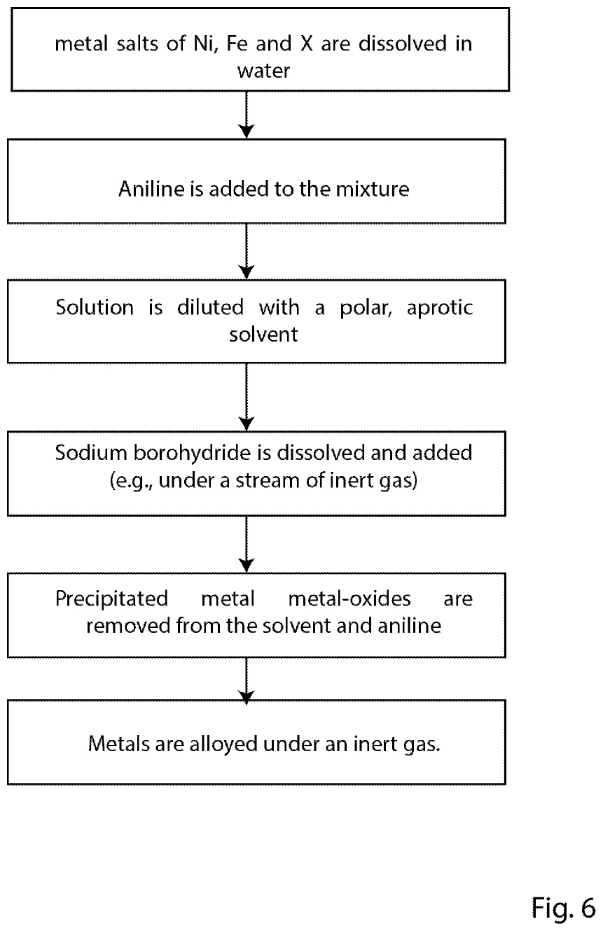

The ternary catalyst of the illustrated embodiment can be prepared using the method shown in FIG. 6 and detailed below:
The respective metal salts of Ni, Fe and X, either chloride, sulfate, or nitrate, are dissolved in water. Amounts of the respective salts so dissolved are determined in accord with the molar ratios below.
Aniline is added to the mixture using a molar excess of 5 to 15 times the moles of dissolved metals.
The solution is diluted with a polar, aprotic solvent such as dimethyl sulfoxide (DMSO), N-methyl pyrrolidone (NMP), or N,N-dimethyl formide (DMF)
Sodium borohydride is dissolved in the solvent from the previous step and added to the salt solution, aniline, and solvent mixture. In some embodiments (e.g., for making larger batches of catalysts), the sodium borohydride solution is kept under a stream of inert gas during the process of adding it to the salt solution.
The precipitated metal metal-oxides are removed from the solvent and aniline via filtration or centrifugation
The metals are alloyed at temperatures between 400 and 700 degrees C. under an inert gas.

The ternary metal catalyst of the illustrated embodiment can be prepared in molar ratios of 8:1:1, 7:2:1, 7:1:2, 6:3:1, 6:2:2, or 6:1:3, where the first number refers to nickel, the second number iron, and the third number is metal X.

The resulting material can have an atomic oxygen content of 40%-70% as determined by energy-dispersive X-ray spectroscopy (EDS) or inductively coupled plasma mass spectroscopy (ICP-MS). The resulting material also has a crystalline lattice size between 5 and 20 angstroms as determined by X-ray diffraction (XRD).

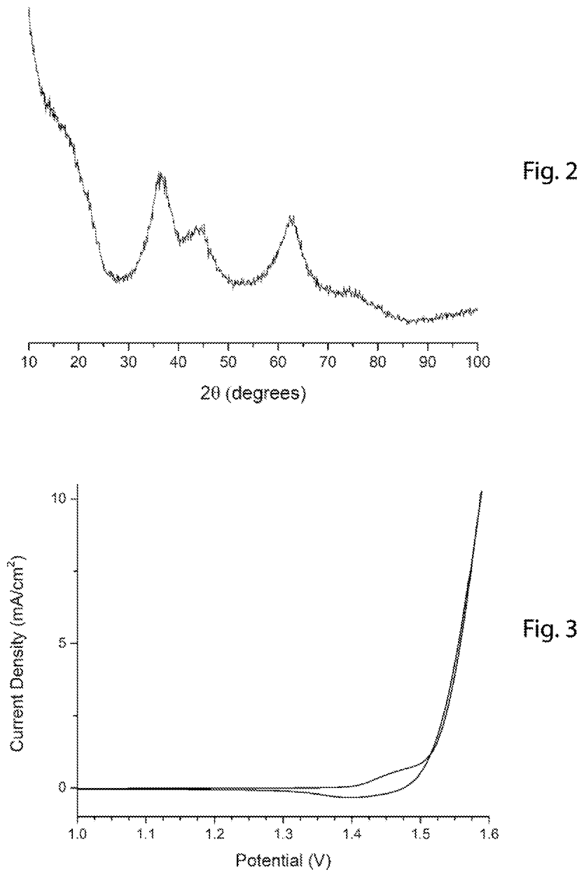

FIG. 2 is an XRD pattern of a NiFeCo catalyst according to the invention with atomic ratios of 6:3:1 (Ni:Fe:Co).

FIG. 3 is a half-cell rotating disc electrode polarization curve of a NiFeCo catalyst with atomic ratios of 6:3:1 (Ni:Fe:Co). The catalyst loading was 250 μg/cm2. The polarization curve was obtained at room temperature with a scan rate of 10 mV/s in 0.1 M KOH. The potentials have been adjusted to correct for solution resistance.

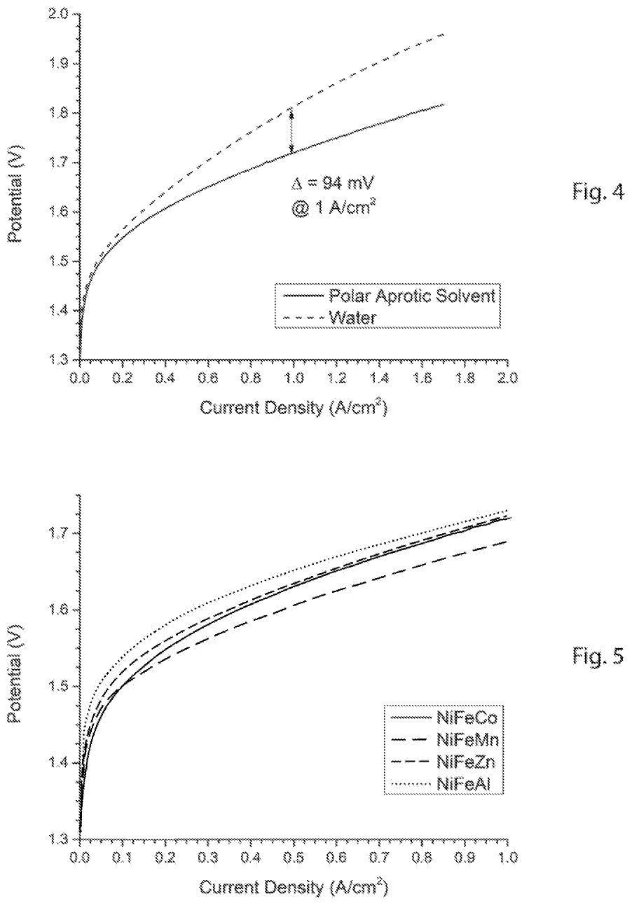

FIG. 4 depicts polarization curves of anion exchange membrane electrolyzer cells using OER catalysts prepared either by using a reducing agent dissolved/dispersed in a polar aprotic solvent (solid) or water (dashed). Both cells used a PGM-free HER catalyst, operated at 90° C., and were fed potassium carbonate only to the anode.

As shown in the drawing, the polarization curves of two cells, one using an OER catalyst prepared by dissolving/dispersing the reducing agent (e.g., sodium borohydride) in a polar aprotic solvent and the other by dissolving/dispersing the reducing agent in water. When the reducing agent is dissolved in water, it deactivates over time, precluding the slow addition of the solution required for the process. By dissolving/dispersing the reducing agent in a polar aprotic solvent, it remains active over a longer period of time as there are no labile sources of hydrogen in the solvent, allowing for a more selective reduction of the metal salts. This technique can be modified for larger batches of catalysts by keeping the solution under a stream of inert gas during the process of adding it to the salt solution. As FIG. 4 shows, dissolving the reducing agent in a polar aprotic solvent reduces the operating potential of electrolyzer cells by nearly 100 mV at 1 A/cm2.

FIG. 5 depict polarization curves of anion exchange membrane electrolyzer cells using NiFeCo, NiFeMn, NiFeZn and NiFeAl with anodes utilizing catalysts according to the invention. In each case, the electrolyzer cells used a PGM-free HER catalyst, operated at 90° C., and were fed potassium carbonate only to the anode.

In contrast to the work done by Bates et al., this a ternary catalyst according to the invention can be free-standing i.e., it need not be loaded on a metal support such as Raney nickel or nickel foam. This was unexpected: to be a viable catalyst without the need for metal supports. Eliminating the need for a metal support layer helps reduce the cost of the electrolyzer cell 10, simplifies assembly, and provides greater utility in how the catalyst is incorporated in the electrode assembly. And, though, the layer 20 of the catalyst can be free-standing, in some embodiments, a support layer 22 (e.g., of Raney Nickel, Nickel foam or otherwise) can be provided to support layer 20 and/or other layers of the anode 14.

Described above are novel ternary catalysts for oxygen evolution reactions, methods of preparation of same, as well as anodes, membrane electrode assemblies and ionomer membrane-based electrolyzer cells utilizing such catalysts. It will be appreciated that the embodiments discussed above and shown in the drawings are examples of the invention and that other embodiments incorporating changes to those shown here also fall within the scope of the invention.

1. An oxygen evolution reaction catalyst comprising Ni, Fe, and a third metal X, where X comprises any of Co, Zn, Al, Mn, or Cr.

2. An oxygen evolution reaction catalyst consisting of Ni, Fe, and a third metal X, where X comprises any of Co, Zn, Al, Mn, or Cr.

3. The catalyst of any of claims 1-2, where X is an alloy of any of Co, Zn, Al, Mn, or Cr.

4. The catalyst of any of claims 1-2, where X consists of any of the elements Co, Zn, Al, Mn, or Cr.

5. The catalyst of any of claims 1-2 prepared in molar ratios of 8:1:1, 7:2:1, 7:1:2, 6:3:1, 6:2:2, or 6:1:3, where a first number in each ratio refers to nickel; a second number in each ratio refers to iron; and, a third number in each ratio refers to the metal X.

6. A method of preparing a ternary catalyst comprising
reducing salts of each of metals Ni, Fe and X in the presence of aniline to yield oxides, hydroxides, and/or oxyhydroxides of each respective metal, where X is any of Co, Zn, Al, Mn, or Cr,
alloying a mixture of said oxides, hydroxides, and/or oxyhydroxides in argon to yield a ternary catalyst.

7. The method of claim 6, wherein the reducing step includes utilizing the aniline to limit particle sizes of the oxides, hydroxides, and/or oxyhydroxides.

8. An anode comprising a catalyst according to any of claims 1-2.

9. (canceled)

10. The anode of claim that lacks a metallic support layer.

11. A membrane electrode assembly comprising an anode according to claim 8.

12. An electrolyzer cell comprising a membrane electrode assembly of claims 11.

13-18 (canceled)

19. A free-standing anode for use in an electrolyzer cell comprising an oxygen evolution reaction catalyst according to claim 1.

20-26 (canceled)
